(19) United States
(12) Patent Application Publication
(10) Pub. No.: US 2012/0294544 A1
(43) Pub. Date: Nov. 22, 2012

(54) IMAGE COMPRESSION METHOD

(75) Inventors: Heng-Yao Lin, Tainan City (TW); Pai-Chu Hsieh, Hsinchu City (TW); Te-Wei Lee, Pingzhen City (TW)

(73) Assignee: Alpha Imaging Technology Corp., Hsinchu County (TW)

(21) Appl. No.: 13/369,051

(22) Filed: Feb. 8, 2012

(30) Foreign Application Priority Data
May 17, 2011 (TW) 100117283

(51) Int. Cl. G06K 9/36

(52) U.S. Cl. 382/238; 382/239

(57) ABSTRACT

An image compression method is provided. Residuals of a lot of pixel data are calculated. Respective compression costs of the residuals of the pixel data are estimated according to a lot of category residual relationships. The compression costs are compared and one of the category residual relationships is selected. The residuals of the pixel data are compressed according to the selected category residual relationship.

This application claims the benefit of Taiwan application Serial No. 100117283, filed May 17, 2011, the subject matter of which is incorporated herein by reference.

### TECHNICAL FIELD

The disclosure relates in general to an image compression method.

### BACKGROUND

In dynamic image compression system, a larger amount of current frames and reference frames are stored for dynamic search to enhance dynamic image compression efficiency. In middle or low resolution compression system, an original un-compressed frame is stored in the memory. Since the resolution of the image is not too high, the required memory space and memory bandwidth are not too large.

However, for the image compression system for high image resolution and high frame rate, a large amount of memory space is required for storing one original un-compressed frame. Consequently, the dynamic image compression system has to allocate a large-capacity memory and occupies a large memory bandwidth.

### BRIEF SUMMARY

The disclosure is directed to an image compression method providing a plurality of category residual relationships from which one is selected based on image characteristic.

According to one embodiment of the present disclosure, an image compression method is provided. A lot of residuals of a lot of pixel data are calculated. Respective compression costs of the residuals of the pixel data are estimated according to a lot of category residual relationships. The compression costs are compared and one of the category residual relationships is selected. The residuals of the pixel data are compressed according to the selected category residual relationship.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a sliding window according to one embodiment of the disclosure; and

FIG. 2 shows a flowchart of an image compression method according to one embodiment of the disclosure.

### DETAILED DESCRIPTION OF THE DISCLOSURE

In one present embodiment of the disclosure, in compressing a high resolution/high frame rate image, a pixel line of a frame of the image is such as divided into segments, but the disclosure is not limited to such exemplification. For example, if a pixel line of a frame includes 4000 pixels, for simplification of hardware implementation, a pixel line is such as divided into 20 segments each including 200 pixels, but the disclosure is not limited to such exemplification.

In the present embodiment of the disclosure, the residuals of the pixels are calculated according to a differential pulse code modulation (DPCM) algorithm. An adjacent pixel (such as the previous pixel) is used as a reference in calculating the difference between the pixel data of two adjacent pixels, and the difference is used as the residual of the pixel.

After the residuals of the pixels are obtained, pixel residuals are categorized according to a plurality of category residual range relationships.

Details of categorization of the present embodiment of the disclosure are disclosed below.

Table 1 and Table 2 are two prediction residual category tables defining a lot of category residual relationships, according to the embodiment of the disclosure.

TABLE 1

| Category | Residual Range |
|---|---|
| 0 | 0 |
| 1 | −1, 1 |
| 2 | −3, −2, 2, 3 |
| 3 | −7, . . . −4, 4, . . . 7 |
| 4 | −15, . . . −8, 8, . . . 15 |
| 5 | −31, . . . −16, 16, . . . 31 |
| 6 | −63, . . . −32, 32, . . . 63 |
| 7 | −127, . . . −64, 64, . . . 127 |
| . . . | . . . |

TABLE 2

| Category | Residual Range |
|---|---|
| 0 | — |
| 1 | — |
| 2 | −2, −1, 1, 2 |
| 3 | −5, . . . −2, 2, . . . 5 |
| 4 | −11, . . . −4, 4, . . . 11 |
| 5 | −23, . . . −8, 8, . . . 23 |
| 6 | −47, . . . −16, 16, . . . 47 |
| 7 | −95, . . . −32, 32, . . . 95 |
| . . . | . . . |

Table 1 and Table 2 are for exemplification purpose only, not for limiting the present embodiment of the disclosure. Other prediction residual category tables defining other category residual relationships may be applicable to other possible embodiments of the disclosure.

Let Table 1 be taken for example. If residuals of 6 pixel data are [1,2,1,2,1,2], then the 6 pixel data are respectively categorized as cat[1], cat[2], cat[1], cat[2], cat[1], cat[2], wherein cat[N] denotes category N and N is a positive integer.

Let Table 2 be taken for example. If residuals of 6 pixel data are [1,2,1,2,1,2], then the 6 pixel data are all categorized as cat[2]. In Table 2, the last category, such as category 7, basically includes all remaining residuals. For example, in the example of an 8-bit pixel data, category 7 not only includes (−95m . . . −32, 32, . . . 95) but should also include (−127, . . . , −32, 32, . . . 127). Here, in the example of an 8-bit pixel data, the residual range is (−255˜255).

In the embodiment of the disclosure, if the pixel is categorized as the last category, this indicates that the difference between two adjacent pixels is huge, and DPCM is not advantageous in compression. When the residual of the pixel is outside the range of the second last category, DPCM is not used, and the pixel is encoded (not to encode the residual of the pixel) and categorized as the last category. Such method is applicable to Table 1 and Table 2.

In compressing the pixel data of the same segment, consecutive residuals of the same category are encoded together, and encoding information is inserted between different categories to mark the current category. Therefore, in compressing the pixel data of the same segment, if category change is frequent, then more encoding information are inserted, and the compression efficiency will deteriorate. To the contrary, if category change is not frequent, then less encoding information are inserted, and the compression efficiency will improve.

In the present embodiment of the disclosure, multiple category residual relationships are provided, and the respective compression costs (for example, the number of bits after compression) of each of the relationships are estimated for determining which category residual range relationship is used in compression. As indicated in the above example, if the residuals of 6 pixel data are [1,2,1,2,1,2], then compression is performed according to Table 2 because Table 2 has a smaller number of category change, and also less encoding information to be inserted.

As indicated in Table 1 and Table 2, the residual range of the current category in Table 2 includes a portion of the residual range of the previous category in Table 1 and a portion of the residual range of the current category in Table 1. Let the category cat[3] of Table 2 be taken for example. The category cat[3] includes 8 residuals, wherein one half of the 8 residuals includes the last 4 residuals of the residual range (−3,−2,2,3) of the previous category cat[2] in Table 1, and the other half of the 8 residuals includes the first 4 residuals of the residual range (−7, . . . −4,4, . . . 7) of the current category cat[3] in Table 1. However, the disclosure is not limited to such exemplification. In alternate embodiment of the disclosure, the residual range of the current category in another table includes the last few residuals of the residual range of the previous category in Table 1 and the first few residuals of the residual range of the current category in Table 1.

In the present embodiment of the disclosure, a look-up table is pre-established based on the relationships of Table 1. The look-up table includes two parts, the first part indicating encoding of Mcat[N], wherein M is a positive integer and Mcat[N] referring that consecutive M residuals are categorized as cat[N]. The second part indicates respective encoding results of the residuals of category cat[N]. Likewise, a look-up table is pre-established based on the relationships of Table 2. The look-up tables established based on Table 1 and Table 2 may be combined into a large one.

The encoding of the present embodiment of the disclosure is further elaborated with the exemplification of 4 residuals (1,1,2,3) of 4 pixel data.

When encoding according to Table 1, the residuals of the 4 pixel data are categorized as cat[1], cat[1], cat[2] and cat[2] respectively, and may be expressed as 2cat[1](1,1) and 2cat[2](2,3) for convenience of elaboration. 2cat[1](1,1) indicates that the residuals (1,1) of 2 consecutive pixel data are categorized as cat[1]. 2cat[2](2,3) has similar meaning.

Another exemplification is further given below, but the present embodiment of the disclosure is not limited thereto. When encoding according to Table 1, 2cat[1] is encoded as “000”, and the residual 1 belonging to cat[1] is encoded as “0”; 2cat[2] is encoded as “001”, residuals 2 and 3 belonging to cat[2] are respectively encoded as “00” and “01”. The above exemplification shows that in encoding according to Table 1, the residuals of the 4 pixel data are encoded as “000000010001”. In encoding, the number of bits is determined according to the residual range of the category. In the example of Table 1, the category 2 (cat[2]) includes 4 residuals (−3,−2,2,3). Therefore, when encoding residuals, the 4 residuals (−3,−2,2,3) are encoded into 2 bits. For example, “00”, “01”, “10” and “11” respectively express (2,3,−2,−3).

Likewise, when encoding residuals according to Table 2, the residuals of the 4 pixel data are respectively categorized as cat[2], cat[2], cat[2] and cat[3], which may expressed as 3cat[2](1,1,2) and 1 cat[3](3). 3cat[2](1,1,2) indicates that the residuals (1,1,2) of 3 consecutive pixel data are categorized as cat[2]. 1cat[3](3) has similar meaning.

When encoding residuals according to Table 2, 3cat[2] is encoded as “0000”, residuals 1 and 2 belonging to cat[2] are respectively encoded as “00” and “01”; 1 cat[3] is encoded as “0001”, and residual 3 belonging to cat[3] is encoded as “000”. The above exemplification shows that when encoding residuals according to Table 2, the residuals of the 4 pixel data are encoded as “00000000010001000”.

The above exemplification shows that when encoding the 4 pixel data, the number of bits after encoding (i.e. the compression costs) obtained according to Table 1 is smaller than that obtained according to Table 2. Therefore, if residuals are encoded according to Table 1, encoding/compression efficiency is better.

In the present embodiment of the disclosure, a sliding window is introduced to further enhance compression efficiency. During encoding, the residuals of the to-be-compressed pixel data are scanned in advance. With respect to residuals of the same amount of pixel data, the compression costs (that is, the number of bits after encoding) of Table 1 and of Table 2 are estimated respectively, and compression is based on the table which has better encoding/compression efficiency (i.e. fewer encoded bit). When comparing the compression costs, the larger the number of the residuals of the pixel data involved in estimation, the more accurate the compression costs. However, if too many residuals of the pixel data are involved in estimation, a larger memory space and more complicated hardware circuit will be needed. Therefore, a balance between the accuracy of estimating the compression costs and the cost of hardware implementation is considered.

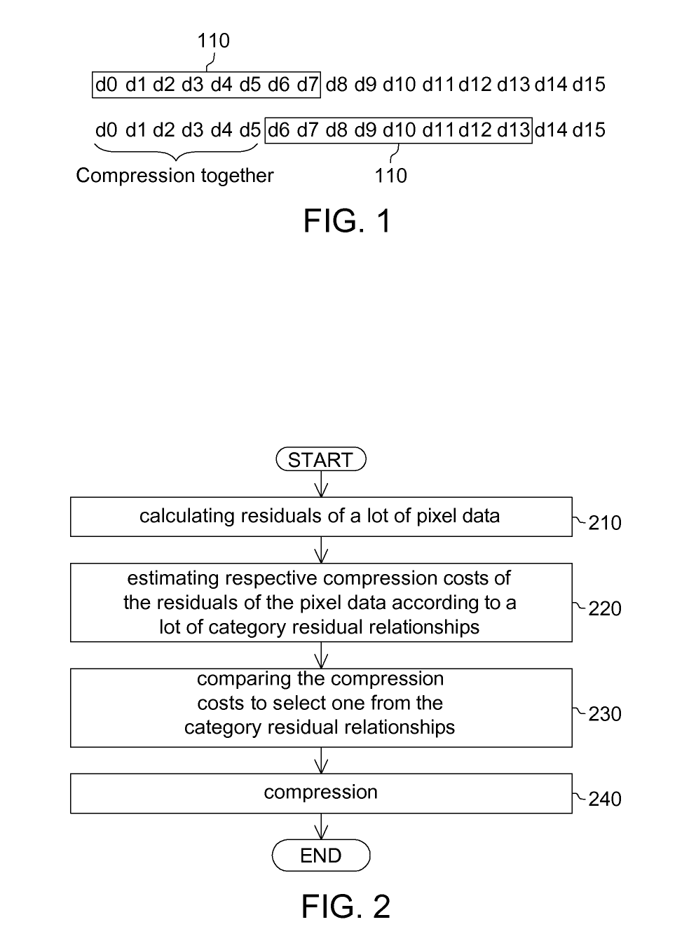

Details of the sliding window are disclosed below. For example, in compressing 200 pixel data, the compression costs are estimated with respect to residuals of some pixel data. FIG. 1 shows a sliding window according to one embodiment of the disclosure. As indicated in FIG. 1, with respect to 8 residuals of pixel data d0˜d7, the first compression cost obtained from Table 1 and the second compression cost obtained from Table 2 are compared to determine which table is used in encoding. Despite FIG. 1 only shows the residuals of the pixel data d0˜d15, however, the present embodiment of the disclosure is not limited thereto.

If one or more residuals of the one or more pixel data next to the current sliding window 110 are in the same category as one or more residuals of the last one or more pixel data in the current sliding window 110, then the compression sequence is changed. Let FIG. 1 be taken for example. Suppose data d6, d7 and d8 belong to the same category. To enhance compression efficiency, better compression efficiency is achieved if the residuals of d6, d7 and d8 are compressed together. Therefore, during compression, it is data d0˜d5, not data d0˜d7, that are first compressed.

For obtaining the compression results of data d0˜d5, the encoding bits of data d6 and d7 are removed from the compression costs estimated from d0˜d7. Then, the sliding window 110 which covers d0˜d7 slides to cover d6˜d13. The above process is repeated until all pixel data of the segment are compressed.

If all residuals of the pixel data covered by the sliding window 110 belong to the same category, then all residuals of the pixel data covered by the sliding window 110 are compressed together and there is no need to determine whether the residuals of the pixel data covered by the sliding window 110 are in the same category as residuals of the pixel data next to the sliding window 110. In other words, the maximum of the M value of Mcat[N] is determined according to the size of the sliding window 110.

In the present embodiment of the disclosure, an image compression method is provided. Referring to FIG. 2, a flowchart of a compression method according to one embodiment of the disclosure is shown.

In step 210, multiple residuals of the pixel data are calculated by such as DPCM, and the details are not repeated here.

In step 220, respective compression costs on the residuals of the pixel data are estimated according to each of the category residual relationships. For example, two compression costs are estimated according to Table 1 and Table 2, respectively, and the details are not repeated here.

In step 230, the compression costs are compared to select one of the category residual relationships. For example, the category residual relationship with lower compression cost is selected, and the details are not repeated here.

In step 240, the residuals of the pixel data are compressed according to the selected category residual relationship.

To further enhance the compression efficiency, a sliding window is introduced in the compression process, and the details are not repeated here.

According to the present embodiment of the disclosure, it is better to compress the residuals belonging to the same category together so as to reduce the number of category change and to enhance compression efficiency. In addition, the present embodiment of the disclosure further provides category residual relationships and the selection from the relationships is based on image characteristic.

It will be appreciated by those skilled in the art that changes could be made to the disclosed embodiments described above without departing from the broad inventive concept thereof. It is understood, therefore, that the the disclosed embodiments are not limited to the particular examples disclosed, but is intended to cover modifications within the spirit and scope of the disclosed embodiments as defined by the claims that follow.

What is claimed is:

1. An image compression method, comprising:
calculating a plurality of residuals of a plurality of pixel data;
estimating respective compression costs of the residuals of the pixel data according to a plurality of category residual relationships;
comparing the compression costs to select one from the category residual relationships; and
compressing the residuals of the pixel data according to the selected category residual relationship.

2. The method according to claim 1, wherein, each category residual relationship comprises a plurality of categories each comprising one or a plurality of prediction residuals.

3. The method according to claim 2, wherein:
the category residual relationships at least comprise a first category residual relationship and a second category residual relationship; and
a current category of the second category residual relationship has a residual range including a portion of a residual range of a previous category of the first category residual relationship and a portion of a residual range of a current category of the first category residual relationship.

4. The method according to claim 1, wherein, the residuals of the pixel data are categorized according to the category residual relationships.

5. The method according to claim 1, further comprising:
compressing the residuals of the pixel data by a sliding window.

6. The method according to claim 5, wherein, respective compression costs of the residuals of the pixel data in the sliding window are estimated according to the category residual relationships;
determining whether residuals of one or more pixel data next to the sliding window are in the same category as residuals of the last one or more pixel data in the sliding window;
if yes, compressing residuals of other pixel data in the sliding window, but temporarily not compressing the residuals of the last one or more pixel data in the sliding window which are in the same category with the residuals of the one or more pixel data next to the sliding window; and
sliding the sliding window.

7. The method according to claim 6, wherein,
if all residuals of the pixel data in the sliding window are in the same category, then all residuals of the pixel data in the sliding window are compressed together.

8. The method according to claim 2, wherein, if the residual of the pixel data is outside a second last category, then the pixel data is compressed, not the residual is compressed, and the residual of the pixel data is categorized as a last category.
